(19) United States
(12) Patent Application Publication
(10) Pub. No.: US 2023/0252589 A1
(43) Pub. Date: Aug. 10, 2023

(54) SYSTEM FOR PROVIDING FOOD

(71) Applicant: Naga Lalitha Kumar Mudiganti, Apex, NC (US)

(72) Inventor: Naga Lalitha Kumar Mudiganti, Apex, NC (US)

(21) Appl. No.: 17/667,121

(22) Filed: Feb. 8, 2022

(51) Int. Cl. G06Q 50/12

(52) U.S. Cl. CPC G06Q 50/12

(57) ABSTRACT

A system for providing food to consumers using a centralized system wherein members of the system employ a complete chain of cooking raw food, consuming the cooked food, delivering the cooked food, and procuring supplies, wherein there is at least one of the group of people that does each of the steps together or independently, which subsequently reduces the costs and efforts associated in delivering cooked meals.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to a system for providing food to consumers in a centralized system, wherein members of the system work together as one system.

### Description of Related Art

The providing of meals to individual homes has become unwieldy and very expensive. Food delivery services allow users to have their food delivered, but not only is there a delivery charge, the cost of the food purchased is also raised. In addition, if different cuisines are desired, one has to make multiple orders from multiple different restaurants.

The isolation of a restaurant serving one cuisine adds to the cost even further. Ordering and acquiring produce, employing staff/workers, along with the cost of delivery creates higher fees and is subsequently more expensive. For example, if there are 10 restaurants, there will be 10 different costs/charges which will only increase depending on proximity (i.e., how far they are from the source and the customers).

### BRIEF SUMMARY OF THE INVENTION

The present invention relates to a system for providing cooked food within an organized group of people in a manner that reduces cost and effort to deliver cooked meals.

Accordingly, in one embodiment, there is a system for providing food to consumers comprising:
a) a geographically connected organized group of people comprising:
   i. people who provide raw food;
   ii. people who do at least one of the steps of cooking the raw food, consuming the cooked food, delivering the cooked food and procuring supplies, wherein there is at least one of the group of people that does each of the steps together or independently;
b) an online ordering system; and
c) a plurality of locations for a plurality of people in the organized group of people to cook the raw food.

### BRIEF DESCRIPTION OF THE DRAWINGS

FIG. 1 is a relationship chart of the various elements of the present invention.

### DETAILED DESCRIPTION OF THE INVENTION

While this invention is susceptible to embodiment in many different forms, there is shown in the drawings, and will herein be described in detail, specific embodiments with the understanding that the present disclosure of such embodiments is to be considered as an example of the principles and not intended to limit the invention to the specific embodiments shown and described. In the description below, like reference numerals are used to describe the same, similar, or corresponding parts in the several views of the drawings. This detailed description defines the meaning of the terms used herein and specifically describes embodiments in order for those skilled in the art to practice the invention.

### Definitions

The terms “about” and “essentially” mean±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, “an embodiment”, or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or”, as used herein, is to be interpreted as an inclusive or meaning any one or any combination. Therefore, “A, B, or C” means any of the following: “A; B; C; A and B; A and C; B and C; A, B, and C”. An exception to this definition will occur only when a combination of elements, functions, steps, or acts are in some way inherently mutually exclusive.

The drawings featured in the figures are for the purpose of illustrating certain convenient embodiments of the present invention and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein, and use of the term “means” is not intended to be limiting.

As used herein, the term “system for providing food to consumers” refers to a system for providing cooked meals to customers wherein the system includes the provisions of raw food, people who cook the raw food, consume the cooked food, deliver the cooked food and procure supplies for cooking the food, wherein, the people are all members of an organized group where at least one of the group of people is responsible for one or more of the elements of the system. By having a closed system, food can be provided at a lower cost than traditional ways of providing and delivering food, such as Grubhub®, which delivers a single meal from a selection of hundreds of restaurants not connected to the consumer.

As used herein, the term “geographically connected organized group of people” refers to the people in the organized group that are part of the system and are all geographically close to one another, such as in a city neighborhood. And that the group of people in the system all fit this requirement.

As used herein, the term “provide raw food” refers to one or more of the people of the organized group providing the raw food and ingredients that are needed to cook the food. This could be from a garden, a farm, or the like.

As used herein, the term “cook the raw food” refers to one or more of the people of the organized group being responsible for cooking and preparing the meals of the system. This can be done in a professional kitchen or in one embodiment, from a member(s) kitchen or a set up kitchen in any location.

As used herein, the term “consume the cooked food” refers to one or more of the people of the organized group who eat the food that is being prepared.

As used herein, the term “deliver the cooked food” refers to one or more of the people of the organized group driving the cooked food in personal or other vehicles to the consuming customer. In one embodiment, instead of one restaurant with one delivery per vehicle, routes can be established allowing the delivery to be for multiple locations for meal drop off.

As used herein, the term “procure supplies” refers to one or more of the people of the organized group finding all the necessary equipment accessories and the like for the cooking, storing, and delivering of the cooked food.

As used herein, the term “group of people that does each of the steps together or independently” refers to one or more of the people of the organized group optionally doing more than one function. For example, one individual can be responsible for both cooking the food and delivering the food.

As used herein, the term “online ordering system” refers to people who consume the food going online to a website or the like to order food for delivery.

As used herein, the term “plurality of locations” refers to having multiple places where the cooking is done. In one embodiment, it is in peoples' kitchens. One could have different locations for each type of food or just split up/divide the work. Other locations could be a rented kitchen, a temporary kitchen, and the like.

As used herein, the term “plurality of people” refers to having multiple people from the group to cook the raw food, consume the food, deliver the food, and procure supplies. While that could all be one person, in one embodiment it is 5, 10, 15, or 20 people.

As used herein, the term “home kitchens” refers to cooking the raw food in one or more home kitchens belonging to the group of people. One advantage of the home kitchen is the much-reduced cost of food preparation. In addition, the person cooking the food will already be familiar with the kitchen, thus preventing a learning curve that occurs when using a new kitchen.

As used herein, the term “route that delivers to multiple locations” refers to delivery accomplished by grouping several meals for distribution to more than one location, as opposed to the one driver-one dish approach used by current delivery services

As used herein, the term “additional connections” refers to finding other pieces of the utilization of the system such as where to buy food, equipment, attain new customers, and the like.

### DRAWINGS

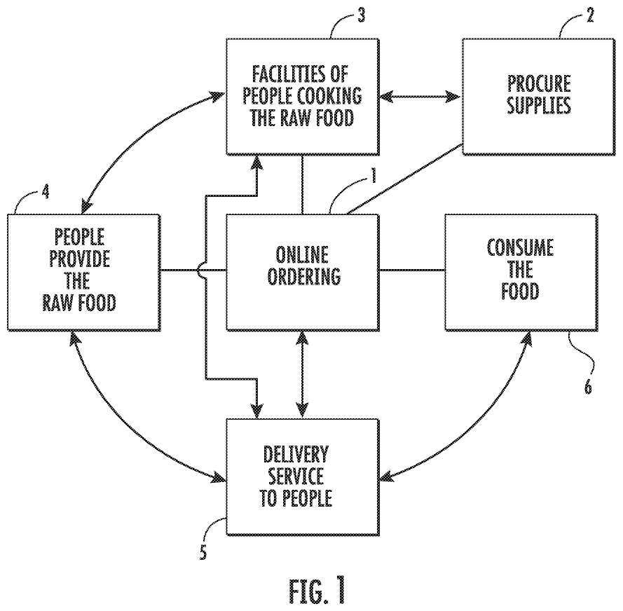

Now referring to the drawings, FIG. 1 is a graphic representation of the system of the present invention. In this view, people are providing the raw food 4 that will be used in the system. The raw food 4 is delivered to the locations/facilities 3 of people cooking the raw food 4. Procuring supplies 2 are delivered where needed. Once the raw food 4 is cooked 3, it is taken by the delivery service 5 for delivery to those that consume the food 6. Ordering and coordination of the system is provided by online ordering system 1.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials, and the like apparent to those skilled in the art still fall within the scope of the invention as claimed by the applicant.

What is claimed is:

1. A system for providing food to consumers comprising:
a) a geographically connected organized group of people comprising:
i. people who provide raw food; and
ii. people who do at least one of the steps of cooking the raw food, consuming the cooked food, delivering the cooked food and procuring supplies, wherein there is at least one of the group of people that does each of the steps together or independently;
b) an online ordering system; and
c) a plurality of locations for a plurality of people in the organized group of people to cook the raw food.

2. The system for providing food to consumers according to claim 1, wherein the plurality of locations includes home kitchens.

3. The system for providing food to consumers according to claim 1, wherein the people who deliver the food have a route that delivers to multiple consumers in a single delivery outing.

4. The system for providing food to consumers according to claim 1, wherein there are one or more additional connections in the organized group of people selected from the group consisting of food type and ethnic background.
